(19) United States
(12) Patent Application Publication
(10) Pub. No.: US 2012/0321950 A1
(43) Pub. Date: Dec. 20, 2012

(54) LITHIUM ION SECONDARY BATTERY

(75) Inventors: Takefumi Okumura, Hitachinaka (JP); Makoto Morishima, Hitachinaka (JP); Kunio Fukuchi, Hitachiota (JP); Erina Yamauchi, Hitachi (JP)

(73) Assignee: HITACHI, LTD., Tokyo (JP)

(21) Appl. No.: 13/523,459

(22) Filed: Jun. 14, 2012

(30) Foreign Application Priority Data
Jun. 14, 2011 (JP) 2011-131787

(51) Int. Cl. H01M 4/60; H01M 4/583; H01M 4/485

(52) U.S. Cl. 429/215

(57) ABSTRACT

A lithium ion battery includes: a positive electrode capable of occluding and emitting lithium ions; a negative electrode that is capable of occluding and emitting lithium ions; a separator disposed between the positive electrode and the negative electrode; and an electrolytic solution. The negative electrode of the lithium ion battery is coated with a lithium ion conductive polymer. The lithium ion battery maintains high-temperature storage characteristics at temperatures of 50° C. or more and output characteristics at room temperature of the lithium ion battery are improved.

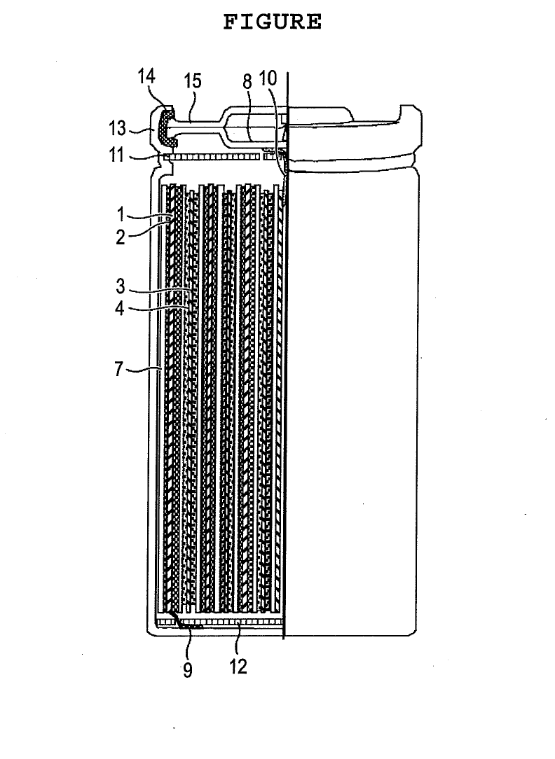

### BACKGROUND OF THE INVENTION

1. Field of the Invention

The present invention relates to a lithium ion battery.

2. Background Art

In consideration of environmental protection and energy saving, a hybrid vehicle in which an engine and a motor are used together as a power source has been developed and has been made into a product. In addition, in the future, development of a fuel cell hybrid vehicle, which uses a fuel cell as a substitute for an engine, will continue to expand.

As an energy source of the hybrid vehicle, secondary batteries in which electricity may be repeatedly charged and discharged are essential technology. Among the secondary batteries, a lithium ion battery is a battery in which the operation voltage is high and a high output is easily gained, and which has high energy density characteristics. In the future, the importance of the lithium ion battery as a power supply of the hybrid vehicle will increase.

The lithium ion battery as the power supply of the hybrid vehicle has a technical problem in that the state of charge is high and it is necessary to suppress an increase in resistance during storage at high temperatures of 50° C. or more.

In the related art, as a countermeasure against the increase in resistance during storage at high temperatures, a countermeasure in which a compound such as vinylene carbonate is added to an electrolytic solution has been suggested. For example, Journal of The Electrochemical Society, 151(10) A1659-A1669 (2004) suggests a battery in which 2 wt % of vinyl carbonate is added to an electrolytic solution composed of LiPF₆, ethylene carbonate, and dimethyl carbonate, and thereby deterioration during storage at 60° C. may be suppressed. According to the addition of the vinylene carbonate, performance deterioration due to growth or the like of a film that precipitates on a negative electrode of the lithium ion battery, and particularly, a decrease in output due to an increase in resistance may be suppressed.

In addition, JP-A-2002-373643 discloses a technology in which a particle surface of at least one of a positive-electrode active material and a negative-electrode active material is partially coated with a lithium ion conductive polymer such as a polyethylene oxide (PEO).

JP-A-2001-176498 discloses a technology in which surfaces of active material particles are coated with a solid electrolyte such as a polyethylene oxide.

In addition, as a solid electrolyte, technologies of JP-A-2005-332699 and JP-A-2005-285416 are disclosed.

However, in the technology of utilizing the vinylene carbonate in the related art, which is disclosed in Journal of The Electrochemical Society, 151(10) A1659-A1669 (2004), as the addition amount increases, suppression of the deterioration during high charging and high-temperature storage is possible but is insufficient, and a decrease in output at room temperature may be caused.

In addition, in the lithium ion conductive polymer such as a polyethylene oxide that is disclosed in JP-A-2002-373643 or JP-A-2001-176498, the transport number of lithium ion and ion conductivity are low, and thereby the high resistance and the decrease in output may be caused in the battery.

### SUMMARY OF THE INVENTION

That is, an object of the invention is to provide a lithium ion battery in which high-temperature storage characteristics at temperatures of 50° C. or more are maintained and output characteristics at room temperature are improved.

According to an aspect of the invention, there is provided a lithium ion battery including: a positive electrode that is capable of occluding and emitting lithium ions; a negative electrode that is capable of occluding and emitting lithium ions; a separator that is disposed between the positive electrode and the negative electrode; and an electrolytic solution. The negative electrode includes a negative-electrode active material and a polymer, a surface of the negative-electrode active material is entirely or partially coated with the polymer, and the polymer includes polyethylene glycol boric acid ester that can be obtained by polymerizing an aliphatic polycarbonate expressed by Formula 1 described below or a polymerizable boron compound expressed by Formula 2 described below.

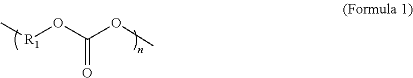

(Here, R₁ represents a hydrocarbon group having a carbon number of 2 to 7, and

n is larger than 10 and less than 10,000)

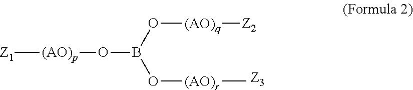

(here, Z₁, Z₂, and Z₃ represent organic groups having an acryloyl group or a methacryloyl group, or hydrocarbon groups having a carbon number of 1 to 10, in which one, two, or three of Z₁, Z₂, and Z₃ are the organic groups having the acryloyl group or methacryloyl group,

AO represents an oxyalkylene group having a carbon number of 1 to 6, and is composed of one kind or two or more kinds thereof, and

p, q, and r represent the average addition number of moles of the oxyalkylene group, and are larger than 0 and less than 4, in which p+q+r is 3 or more).

According to this aspect of the invention, a lithium ion battery, in which the output characteristics at room temperature are improved while deterioration during high-temperature storage of the lithium ion battery is suppressed, may be provided. Objects, configurations, and effects other than those described above will be apparent through the following description of embodiments.

### BRIEF DESCRIPTION OF THE DRAWINGS

The FIGURE is a one-side cross-sectional view of a wound-type battery according to an embodiment of the invention.

### DETAILED DESCRIPTION OF THE INVENTION

Hereinafter, an embodiment of the invention will be described with reference to the attached drawing or the like. The following description illustrates a specific example of the content of the invention. The invention is not limited to this description, and various modifications and variations may be made by a person skilled in the art without departing from a technical scope disclosed in this specification. In addition, in the drawing to explain the invention, like reference numerals will be given to like parts having substantially the same functions, and redundant description thereof will not be repeated.

An object of the invention is to provide a lithium ion battery in which output characteristics at room temperature are improved without deteriorating high-temperature storage characteristics at temperature of 50° C. or more.

Since a potential discharged by the lithium ion battery is very low, it is very difficult to obtain a stable electrolytic solution that is not subjected to reduction during a discharge reaction. In many cases, when there is a side reaction product, which is generated by a reductive decomposition of a component in the electrolytic solution, an increase in resistance is caused. Therefore, an attempt to form a stable film has been made in order for the side reaction that causes the increase in resistance not to occur between an electrode and the electrolytic solution.

Journal of The Electrochemical Society, 151(10) A1659-A1669 (2004) discloses a technology in which a stable film of vinylene carbonate is formed at the periphery of the electrode so as to suppress the side reaction. In addition, JP-A-2002-373643 discloses a technology in which a particle surface of at least one of a positive-electrode active material and a negative-electrode active material is partially coated with a lithium ion conductive polymer such as a polyethylene oxide.

However, in a case where the lithium ion battery is stored at high temperatures of 50° C. or more, there is a problem in that thermal decomposition and thermal dissolution of the coated film occur and the side reaction is promoted. As a countermeasure for this problem, the film is made to be thick. However, due to an increase in the film thickness, resistance increases and therefore output characteristics at room temperature may be deteriorated.

The output decrease is mainly because the transport number of lithium ion and ion conductivity of the formed film are low, and as a result, high resistance and a decrease in output of the battery may be caused. The invention provides a lithium ion battery in which the output characteristics at room temperature are improved while not deteriorating the high-temperature storage characteristics at 50° C. or more by coating a negative electrode in an appropriate shape with a polymer in which the transport number of lithium ion and the ion conductivity are high.

According to a first embodiment of the invention, there is provided a lithium ion battery including: a positive electrode that is capable of occluding and emitting lithium ions; a negative electrode that is capable of occluding and emitting lithium ions; a separator that is disposed between the positive electrode and the negative electrode; and an electrolytic solution, in which the negative electrode is coated with a lithium ion conductive polymer. A surface of a negative-electrode active material may be partially coated with the lithium ion conductive polymer, or the entirety of the surface of the negative-electrode active material may be coated with the lithium ion conductive polymer. From the point of view of lithium ion conductivity, it is preferable that the negative-electrode active material be partially coated with some degree of gaps instead of being entirely coated. In addition, a polymer other than the lithium ion conductive polymer may be included in the surface of the negative-electrode active material, or only the lithium ion conductive polymer may be present as a polymer that is present in the surface of the negative-electrode active material. This film may cause age deterioration, such that a film thickness, a coverage factor, and the like in a film after the battery is used may further decrease compared to those in a film at the time of manufacturing the battery. Therefore, the coverage factor at the time of manufacturing the battery may vary depending on the age of service of the battery and a usage environment.

In addition, when the lithium ion conductive polymer is cross-linked by carbonate containing a polymerizable portion in a molecule, strength of the film increases and thereby the high-temperature characteristics may be improved.

The lithium ion conductive polymer includes polyethylene glycol boric acid ester in which a starting material is at least an aliphatic polycarbonate expressed by Formula 1 described below or a monomer expressed by Formula 2 described below.

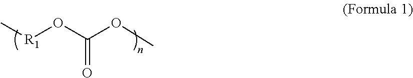

Here, R₁ represents a hydrocarbon group having a carbon number of 2 to 7.

n is larger than 10 and less than 10,000.

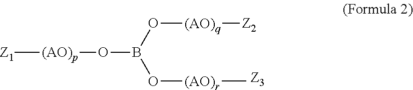

Here, Z₁, Z₂, and Z₃ represent organic groups having an acryloyl group or a methacryloyl group, or hydrocarbon groups having a carbon number of 1 to 10, in which one, two, or three of Z₁, Z₂, and Z₃ are the organic groups having the acryloyl group or methacryloyl group.

AO represents an oxyalkylene group having a carbon number of 1 to 6, and is composed of one kind or two or more kinds thereof.

p, q, and r represent the average addition number of moles of the oxyalkylene group, and are larger than 0 and less than 4, in which p+q+r is 3 or more.

The polyethylene glycol boric acid ester in which a starting material is the aliphatic polycarbonate expressed by Formula 1 or the monomer expressed by Formula 2 has high ion conductivity. Therefore, in a film using this polymer, even when the film thickness increases, the increase in resistance is small, and therefore the high-temperature characteristics may increase.

In addition, in the polymer in which the ion conductivity is high, a charge may flow smoothly. Therefore, leakage of the charge into an electrolytic solution component is small. As a result, precipitation of the electrolytic solution component is suppressed and therefore an increase in resistance of the battery may be suppressed.

One, two, or three of Z₁, Z₂, and Z₃ are the organic groups having the acryloyl group or methacryloyl group. From the point of view of ion conductivity, one or two is preferable. When one or two among three side chains of boron are made to have a degree of freedom while not being used in polymerization, activation energy when lithium ions are conducted to the same functional group as an adjacent side chain by the movement of the side chain is reduced and thereby a polymer electrolytic solution in which the temperature dependency of the ion conductivity is excellent may be expected.

The aliphatic polycarbonate in this invention includes a structure of —O—(C═O)—O— and an aliphatic hydrocarbon group having a carbon number of 2 to 7 in a molecule. As the aliphatic hydrocarbon group, for example, ethylene, propylene, butylene, pentylene, dimethyl trimethylene, dimethyl tetramethylene, dimethyl pentamethylene, or the like may be exemplified. Here, as the carbon number is large, the ratio of a carbonate group in a constant weight decreases, such that for example, a region in which lithium ions may be coordinated decreases, the ion conductivity decreases, and therefore the battery resistance is raised. As a result, this is not preferable. On the other hand, if the carbon number is small, it is easy for a polymer to crystallize, and thereby movement of ions may be interrupted. Therefore, the carbon number is preferably 2 to 3. In addition, n in Formula 1 is the addition number of moles. n is larger than 10 and less than 10,000, and preferably larger than 100 and less than 1,000. When n is 10 or less, the polymer is apt to be eluted into the electrolytic solution, such that maintenance of the function for a long period of time becomes impossible. When molecular weight is 10,000 or more, the molecular weight is too much, such that handling becomes difficult. Particularly, slurry viscosity at the time of manufacturing an electrode becomes high, and therefore electrode coating properties may be deteriorated.

The polyethylene glycol boric acid ester of the invention is a polymer of a boric acid ester compound expressed by Formula 2. The boric acid ester compound includes one kind or two or more kinds of oxyalkylene groups. As the oxyalkylene group, an oxyethylene group, an oxypropylene group, an oxybutylene group, an oxytetramethylene group, or the like may be exemplified. The carbon number is preferably 2 to 4. From the point of view of ease of manufacturing the boric acid ester compound, the oxyethylene group is more preferable. In addition, from the point of view of applying plasticity to an electrode that may be obtained, the oxypropylene group is more preferable. In the boric acid ester compound expressed by Formula 2, Z₁, Z₂, and Z₃ represent organic groups having an acryloyl group or a methacryloyl group, or hydrocarbon groups having a carbon number of 1 to 10. Two or more kinds of the compounds in which the groups of Z₁ to Z₃ are different from each other may be used. Preferably, Z₁ to Z₃ include the organic groups including the acryloyl group or the methacryloyl group, in an average ratio of 1/10 or more. More preferably, Z₁ to Z₃ include the organic groups including the acryloyl group or the methacryloyl group, in an average ratio of 1/5 or more. Preferably, all of Z₁ to Z₃ are the organic groups including the acryloyl group or the methacryloyl group. In a case where Z₁ to Z₃ include the organic groups including the acryloyl group or the methacryloyl group, in the average ratio of 1/10 or more, the electrode may be manufactured without using another binding agent component, and in the case of the average ratio of 1/5 or more, mechanical strength may be sufficiently exhibited. As the organic groups including the acryloyl group or the methacryloyl group, organic groups including the acryloyl group or the methacryloyl group at a distal end, preferably, the acryloyl group or the methacryloyl group may be exemplified. The carbon number of the hydrocarbon group is 1 to 10, for example, aliphatic hydrocarbon groups such as a methyl group, an ethyl group, a propyl group, a butyl group, a pentyl group, a hexyl group, a heptyl group, an octyl group, a nonyl group, and a decyl group, aromatic hydrocarbon groups such as a phenyl group, a toluyl group, and a naphthyl group, and alicyclic hydrocarbon groups such as a cyclopentyl group, a cyclohexyl group, a methyl cyclohexyl group, and a dimethyl cyclohexyl group may be exemplified. A hydrocarbon group having the carbon number of 4 or less is preferable, and a methyl group having the carbon number of 1 is particularly preferable. In the boric acid ester compound expressed by Formula 2, p, q, and r represent the average addition number of moles of the oxyalkylene group. p, q, and r are larger than 0 and less than 100, and preferably 1 to 20. From the point of view of increasing ion conductivity, p, q, and r are more preferably 1 to 3, and from the point of view of exhibiting plasticity of the electrode that is obtained, p, q, and r are more preferably 3 to 20. p+q+r is 3 or more, and preferably 3 to 60. From the point of view of increasing ion conductivity, p+q+r is more preferably 3 to 9, and with respect to exhibiting the plasticity of the electrode that is obtained, p+q+r is more preferably 5 to 60.

The polyethylene glycol boric acid ester in which starting materials are the aliphatic polycarbonate expressed by Formula 1 and the monomer expressed by Formula 2 may be used as a solid electrolyte. In the case of being used as the solid electrolyte, the lithium ion moves through solid not through an electrolytic solution. Since ion conductivity of a liquid is higher than that of a solid, in a case where the polymer of Formula 1 and Formula 2 is used as the solid electrolyte, the output is lower compared to a case where a liquid electrolyte is generally used.

However, like the present application, in a case where a polymer is used for the coating of an active material and a liquid electrolyte is mainly used for an ion conductive medium, the ion conductivity is high.

In a case where the polyethylene glycol boric acid ester in which starting materials are the aliphatic polycarbonate expressed by Formula 1 and the monomer expressed by Formula 2 is used for the coating of the negative electrode, this polymer is easily exposed to the electrolyte, such that it is necessary to suppress elution into the electrolytic solution. When n is 10 or less, since the polymer may be eluted into the electrolytic solution, maintenance of the function for a long period of time may be difficult. Therefore, it is preferable that the range of n be larger than 100 and less than 10,000.

As a method of coating the negative-electrode active material with the lithium ion conductive polymer in the present invention, for example, a method of directly pre-coating the negative-electrode active material with the lithium ion conductive polymer may be exemplified. For example, in this method, the negative-electrode active material is dispersed in an organic solvent solution of the lithium ion conductive polymer and a precipitate is dried in a high-temperature atmosphere. As the organic solvent, a well-known solvent, for example, an organic solvent capable of dissolving a lithium ion conductive polymer such as acetone, acetonitrile, and ethyl acetate may be used. In addition, as a method of mechanically coating the lithium ion conductive polymer, a hybridization method, a mechano-fusion method, and a mechanical milling method using a ball mill may be used.

As a method of coating the negative-electrode active material with the lithium ion conductive polymer, a pre-coating method is preferable also from the point of view of components making up a film. In a case where a film is formed by an operation potential after a battery operates, in addition to a coating component, an inorganic lithium salt such as LiPF₆ and LiBF₄ may be mixed in as a component of the film. This inorganic lithium salt becomes a cause of an increase in resistance. On the other hand, in the method of pre-coating the negative-electrode active material with the coating component, since the negative-electrode active material may be coated in advance with the polymer in which ion conductivity is high, precipitation of the inorganic lithium salt may be suppressed.

In the present invention, the carbonate, which contains the polymerizable portion in a molecule at least, includes a circular carbonate expressed by Formula 3 described below or a chain-shaped carbonate expressed by Formula 4 described below.

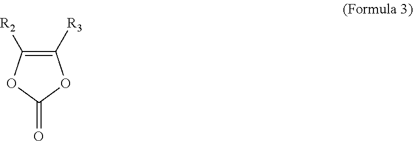

Here, R₂ and R₃ represent at least one kind of hydrogen, fluorine, chlorine, an alkyl group having a carbon number of 1 to 3, and a fluorinated alkyl group.

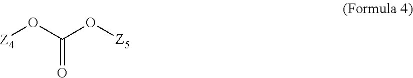

Here, Z₄ and Z₅ represent a polymerizable functional group including at least one kind of an allyl group, a methallyl group, a vinyl group, an acryl group, and a methacryl group.

As the compound expressed by Formula 3, vinylene carbonate (VC), methyl vinylene carbonate (MVC), dimethyl vinylene carbonate (DMVC), ethyl vinylene carbonate (EVC), diethyl vinylene carbonate (DEVC), or the like may be used. The VC has a small molecular weight, and is considered to form a dense electrode film. The MVC, DMVC, EVC, DEVC, or the like in which the VC is substituted with an alkyl group is considered to form a less dense electrode film in correspondence with a size of an alkyl chain and is considered to effectively act on improvement of low-temperature characteristics. As the compound expressed by Formula 4, for example, dimethallyl carbonate (DMAC) may be exemplified.

The lithium ion conductive polymer is cross-linked by a cross-linking agent such as the circular carbonate expressed by Formula 3 and the chain-shaped carbonate expressed by Formula 4, and thereby the strength of the film may be improved. Since the strength of the film may be improved, the high-temperature characteristics may be improved without increasing the film thickness. As the cross-linking agent, the material of Formula 3 or Formula 4 may be used alone or maybe used after being combined. A material other than those of Formula 3 and Formula 4 maybe included in the cross-linking agent, or only the material of Formula 3 or Formula 4 may be used.

When the polyethylene glycol boric acid ester in which the starting materials are the aliphatic polycarbonate expressed by Formula 1 and the monomer expressed by Formula 2 is cross-linked by the circular carbonate expressed by Formula 3 or the chain-shaped carbonate expressed by Formula 4, a film having a higher strength and a lower resistance may be formed. The cross-linking agent is not limited to the compound expressed by Formula 3 or Formula 4, and may be any material as long as this material is capable of cross-linking the compound expressed by Formula 1 or the compound expressed by Formula 2. From the point of view of a side reaction, it is preferable that as the cross-linking agent, the compound expressed by Formula 3 or Formula 4 be used.

The positive electrode is formed by applying a positive-electrode mixture layer including a positive-electrode active material, an electronic conductive material, and a binder on aluminum foil that is a collector. In addition, a conducting agent may be further added to the positive-electrode mixture layer so as to reduce electronic resistance.

As the positive-electrode active material, lithium composite oxides that are expressed by a compositional formula of Li_{α}MnₓM1_{y}M2_{z}O₂ (in Formula, M1 represents at least one kind selected from Co and Ni, M2 represents at least one kind selected from Co, Ni, Al, B, Fe, Mg, and Cr, x+y+z =1, 0<α1.2, 0.2≦x≦0.6, 0.2≦y≦0.4, and 0.05≦z≦0.4) is preferable. In addition, among these lithium composite oxides, a lithium composite oxide in which M1 is Ni or Co, and M2 is Co or Ni is more preferable. Furthermore, LiMn_{1/3}Ni_{1/3}Co_{1/3}O₂ is more preferable. In the composition, when Ni increases, capacity may increase, when Co increases, output at a low temperature may be improved, and when Mn increases, the material cost may be suppressed. In addition, an addition element is effective to stabilize cycle characteristics. In addition to this, an orthorhombic phosphate compound, which has a symmetric property of a space group Pmnb, of a general formula of LiMₓPO₄ (M: Fe or Mn, 0.01≦X≦0.4) or LiMn₁₋ₓMₓPO₄ (M: a bivalent cation other than Mn, 0.01≦X≦0.4) is also preferable. Particularly, LiMn_{1/3}Ni_{1/3}CO_{1/3}O₂ has excellent low-temperature characteristics and high cycle stability, and therefore is suitable as a lithium battery material for a hybrid vehicle (HEV). The binder may be any binder as long as this binder allows the material making up the positive electrode and a positive-electrode collector to closely adhere to each other. As this binder, for example, a homopolymer or copolymer such as vinylidene fluoride, tetrafluoroethylene, acrylonitrile, and an ethylene oxide, a styrene butadiene rubber, or an orthorhombic phosphate compound having a symmetric property of a space group Pmnb is also preferable. Particularly, LiMn_{1/3}Ni_{1/3}Co_{1/3}O₂ has excellent low-temperature characteristics and high cycle stability, and therefore is suitable as a lithium battery material for a hybrid vehicle (HEV). The binder may be any binder as long as this binder allows the material making up the positive electrode and the positive-electrode collector to closely adhere to each other. As this binder, for example, a homopolymer or copolymer such as vinylidene fluoride, tetrafluoroethylene, acrylonitrile, and an ethylene oxide, a styrene butadiene rubber, or the like may be exemplified. The conductive agent is, for example, a carbon material such as carbon black, graphite, a carbon fiber, and metal carbide, and these may be used alone or may be used after being mixed.

The negative electrode of the invention is formed by applying a negative-electrode mixture layer including negative-electrode active material and a binder on copper foil that is a collector. In addition, a conducting agent may be further added to the negative-electrode mixture layer so as to reduce electronic resistance. As materials that are used as the negative-electrode active material, carbonaceous materials, oxides including a group IV element, and nitrides including a group IV element may be exemplified. As the carbonaceous materials, natural graphite, a composite carbonaceous material in which a film is formed on the natural graphite by a dry type CVD (Chemical Vapor Deposition) method or a wet type spray method, artificial graphite that is manufactured by baking a resin raw material such as epoxy and phenol or a pitch-based material that may be obtained from petroleum or coal as a raw material, amorphous carbon material, or the like may be exemplified. As the oxides including the group IV element and the nitride including the group IV element, oxides or nitrides of silicon, germanium, tin, or the like that form a compound with lithium, and are inserted into an inter-crystal gap, and are capable of occluding and emitting lithium ions. In addition, these may be generally called the negative-electrode active material. Particularly, the carbonaceous materials have high conductivity, and are excellent materials from the point of view of the low-temperature characteristics and the cycle stability. Among the carbonaceous materials, a material in which an inter-layer distance (d₀₀₂) of a carbon network surface layer is wide is suitable because rapid charging and discharging or the low-temperature characteristics are excellent. However, in the material in which the d₀₀₂ is wide, since capacity may decrease or charging and discharging efficiency may be low at an initial stage of charging, it is preferable that d₀₀₂ be 0.390 nm or less, and this carbonaceous material may be called a pseudo-anisotropic carbon. Furthermore, a carbonaceous material such as graphite carbon, amorphous carbon, and activated carbon in which conductivity is high may be mixed to construct an electrode. In addition, as the graphite carbon material, a material having the characteristics of (1) to (3) described below may be used.

(1) An R value (I_{D}/I_{G}), which is an intensity ratio of a peak intensity (I_{D}) that is within a range of 1, 300 to 1,400 cm⁻¹ and is measured by Raman spectroscopy, and a peak intensity (I_{G}) that is within a range of 1, 580 to 1, 620 cm⁻¹ and is measured by Raman spectroscopy, is 0.20 to 0.40.

(2) A half width Δ of a peak that is within a range of 1,300 to 1,400 cm⁻¹ and is measured by Raman spectroscopy is 40 cm⁻¹ to 100 cm⁻¹.

(3) An intensity ratio X (I₍₁₁₀₎/I₍₀₀₄₎) of a peak intensity (I₍₁₁₀₎) of a (110) plane and a peak intensity (I₍₀₀₄₎) of a (004) plane in an X-ray diffraction is 0.10 to 0.45.

The binder may be any binder as long as this binder allows the material making up the negative electrode and a negative-electrode collector to closely adhere to each other. As this binder, a homopolymer or copolymer such as vinylidene fluoride, tetrafluoroethylene, acrylonitrile, and an ethylene oxide, a styrene butadiene rubber, or the like may be exemplified.

The conductive agent is, for example, a carbon material such as carbon black, graphite, a carbon fiber, and metal carbide, and these may be used alone or may be used after being mixed.

In addition, a silane treatment, an aluminum treatment, and a titanium treatment of the negative-electrode active material are effective to increase coating efficiency of the lithium ion conductive polymer. The silane treatment, the aluminum treatment, and the titanium treatment in the invention represent that an active material is treated by a treating agent such as a compound expressed by Formula 5 described below and a silicate compound expressed by Formula 9 described below.

YMXₚ (Formula 5)

In the formula, M is selected from silicon, aluminum, and titanium. As Y, CH₂═CH—, CH₂═C(CH₃)COOC₃H₆—,

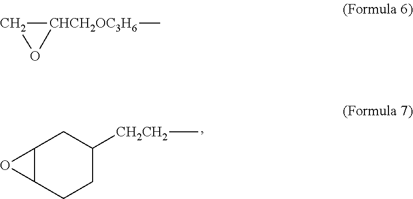

NH₂C₃H₆—, NH₂C₂H₄NHC₃H₆—, NH₂COCHC₃H₆—, CH₃COOC₂H₄NHC₂H₄NHC₃H₆—, NH₂C₂H₄NHC₂H₄NHC₃H₆—, SHC₃H₆—, ClC₃H₆—, CH₃—, C₂H₅—, C₂H₅OCONHC₃H₆—, OCNC₃H₆—, C₆H₅—, C₆H₅CH₂NHC₃H₆—, C₆H₅NHC₃H₆—, CH₃O—, C₂H₅O—, C₃H₇O—, iso-C₃H₇O—, C₄H₉O—, sec-C₄H₉O—, tert-C₄H₉O—, C₄H₉CH(—C₂H₅) CH₂O—, or the like may be exemplified. In addition, as X, groups such as —OCH₃, —OC₂H₅, —OC₃H₇, —O-iso-C₃H₇, —OC₄H₉, —O-sec-C₄H₉, —O-tert-C₄H₉, —O—CH₂CH(—C₂H₅)C₄H₉, —OCOCH₃, —OC₂H₄OCH₃, —N(CH₃)₂, and —Cl, and

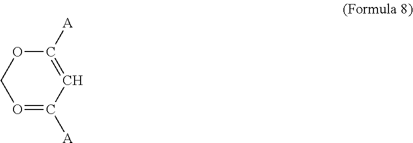

(in the formula, A represents an alkyl group having a carbon number of 1 to 3) may be exemplified. In a case where M is silicon or titanium, p is 3, and in a case where M is aluminum, p is 2.

RO—[Si(—OR)₂—O—]_{q}R (Formula 9)

In the formula, R is a group selected from a methyl group, an ethyl group, a propyl group, an isopropyl group, a butyl group, an isobutyl group, and a t-butyl group, and q is from 2 to 30. Specific examples of the compound of the (Formula 2) and (Formula 9) include vinyltriethoxysilane, vinyltrimethoxysilane, vinyltrichlorosilane, vinyltris(2-methoxyethoxy)silane, γ-methacryloxypropyltrimethoxysilane, γ-methacryloxypropyltriethoxysilane, γ-aminopropyltriethoxysilane, γ-aminopropyltrimethoxysilane, N-β-(aminoethyl)-γ-aminopropyltrimethoxysilane, N-β-(aminoethyl)-γ-aminopropyltriethoxysilane, γ-ureidopropyltriethoxysilane, γ-ureidopropyltrimethoxysilane, β-(3,4-epoxycyclohexyl)ethyltrimethoxysilane, β-(3,4-epoxycyclohexyl)ethyltriethoxysilane, γ-glycidoxypropyltrimethoxysilane, γ-glycidoxypropyltriethoxysilane, γ-mercaptopropyltrimethoxysilane, γ-mercaptopropyltriethoxysilane, γ-chloropropyltrimethoxysilane, γ-chloropropyltriethoxysilane, methyltriethoxysilane, methyltrimethoxysilane, phenyltriethoxysilane, phenyltrimethoxysilane, aluminum ethylate, aluminum isopropylate, aluminum diisopropylate mono-sec-butylate, aluminum-sec-butylate, aluminum ethyl acetoacetate diisopropylate, aluminum tris(ethyl acetoacetate), aluminum tris(acetyl acetonate), aluminum bisethyl acetoacetate monoacetyl acetonate, tetramethoxytitanium, tetraethoxytitanium, tetraisopropoxytitanium, tetra-n-butoxytitanium, diethoxybis(ethyl acetoacetate)titanium, diethoxybis(acetyl acetoacetate) titanium, diisopropoxybis(ethyl acetoacetate) titanium, isopropoxy(2-ethyl-1,3-hexanediolato)titanium, tetraacetyl acetate titanium, and the like. Among these, preferred examples thereof include vinyltriethoxysilane, vinyltrimethoxysilane, vinyltris(2-methoxyethoxy)silane, γ-methacryloxypropyltrimethoxysilane, γ-methacryloxypropyltriethoxysilane, γ-aminopropyltriethoxysilane, γ-aminopropyltrimethoxysilane, N-β-(aminoethyl)-γ-aminopropyltrimethoxysilane, N-⊖-(aminoethyl)-γ-aminopropyltriethoxysilane, γ-ureidopropyltriethoxysilane, γ-ureidopropyltrimethoxysilane, β-(3,4-epoxycyclohexyl)ethyltrimethoxysilane, β-(3,4-epoxycyclohexyl)ethyltriethoxysilane, γ-glycidoxypropyltrimethoxysilane, γ-glycidoxypropyltriethoxysilane, aluminum ethylate, aluminum isopropylate, aluminum ethyl acetoacetate diisopropylate, aluminum tris(ethyl acetoacetate), aluminum tris(acetyl acetonate), aluminum bisethyl acetoacetate monoacetyl acetonate, tetramethoxytitanium, tetraethoxytitanium, tetraisopropoxytitanium, diethoxybis(ethylacetoacetate)titanium, diethoxybis(acetyl acetoacetate) titanium, diisopropoxybis(ethyl acetoacetate)titanium, and tetraacetyl acetate titanium, and more preferred examples thereof include vinyltriethoxysilane, vinyltrimethoxysilane, vinyltris(2-methoxyethoxy)silane, γ-methacryloxypropyltrimethoxysilane, γ-aminopropyltriethoxysilane, N-β-(aminoethyl)-γ-aminopropyltrimethoxysilane, γ-ureidopropyltriethoxysilane, β-(3,4-epoxycyclohexyl)ethyltrimethoxysilane, γ-glycidoxypropyltrimethoxysilane, aluminum ethylate, aluminum tris(ethyl acetoacetate), aluminum tris(acetyl acetonate), aluminum bisethyl acetoacetate monoacetyl acetonate, tetramethoxytitanium, tetraethoxytitanium, diethoxybis(ethyl acetoacetate)titanium, diethoxybis(acetyl acetoacetate)titanium, and tetraacetyl acetate titanium. The mechanism by which an excellent effect may be obtained by the silane treatment is not clear, but this is considered to be because surface adsorbed water or a surface functional group, which is considered to chemically react with lithium and does not contribute to the charging and discharging reaction of the battery, decreases due to improvement of a water resisting property (a lipophillic property). In addition, the same effect may be obtained by the aluminum treatment or the titanium treatment using an organic titanium compound and these kinds of treatment are also useful. The silane treatment is preferable from the point of view of availability of a raw material or the like. The amount of the treating agent used in the invention is not particularly limited, but it is preferable that this amount is determined in consideration of a specific surface area S of carbon powders that are used. That is, although being different depending on the kind of treating agent, since it is estimated that an area of substantially 100 to 600 m² may be coated by 1 g (S=(m²/g)), when the specific surface area of the carbon powders that are used is set to A(m²/g), the amount of the treating agent per 1 g of carbon powders, which is A/S (g), is preferably made as a reference. However, even in a used amount with which a total surface area of the carbon powers may not be coated with the treating agent, an irreversible capacity may be made to be significantly small. When being described in more detail, it is preferable that the amount of the treating agent be 0.01 weight parts to 20 weight parts with respect to 100 weight parts of the carbon powers that are used, more preferably 0.1 weight parts to 10 weight parts, and particularly preferably 0.5 weight parts to 5 weight parts. In addition, a method of treating the active material with the treating agent is not particularly limited, but as an example, a method in which the compound expressed by Formula 5 is made to react with water to hydrolyze a part or the entirety of the compound, and the hydrolyzed compound is added to active material powers in a necessary amount, and then the resultant mixed material is dried in a heating oven, or a method in which a solution obtained by dissolving the silicate compound expressed by Formula 9 in alcohol of a low molecular weight is added to active material powers in a necessary amount, and then the resultant mixed material is made to react and is dried in a heating oven.

In addition, the electrolytic solution includes circular carbonate, chain-shaped carbonate, and a lithium salt. As the circular carbonate, ethylene carbonate (EC), trifluoropropylene carbonate (TFPC), chloroethylene carbonate (ClEC), fluoroethylene carbonate (FEC), trifluoroethylene carbonate (TFEC), difluoroethylene carbonate (DFEC), vinyl ethylene carbonate (VEC), or the like may be used. Particularly, from the point of view of forming a film on the negative electrode, it is preferable to use EC. In addition, even when a small amount (2 vol % or less) of ClEC, FEC, TFEC, or VEC is added, this addition participates in the formation of the electrode film, and provides preferable cycle characteristics. Furthermore, a small amount (2 volt or less) of TFPC or DFEC may be added and used from the point of view of formation of a film on the positive electrode. As the chain-shaped carbonate, dimethyl carbonate (DMC), ethyl methyl carbonate (EMC), diethyl carbonate (DEC), methyl propyl carbonate (MPC), ethyl propyl carbonate (EPC), trifluoromethyl ethyl carbonate (TFMEC), 1,1,1-trifluoroethyl methyl carbonate (TFEMC), or the like may be used. DMC is a solvent having high compatibility, and is suitable to be used after being mixed with EC or the like. DEC has a melting point lower than that of DMC, and is suitable for low temperature (−30° C.) characteristics. EMC has a molecular structure that is asymmetric and has a low melting point, and therefore is suitable for the low-temperature characteristics. EPC and TFMEC have a propylene side chain, and have a molecular structure that is asymmetric, and therefore are suitable as a low-temperature characteristic adjusting solvent. A portion of molecules of TFEMC is fluorinated and therefore a dipole moment of TFEMC becomes large. As a result, TFEMC is suitable to maintain dissociation of the lithium salt at a low temperature and is suitable for the low-temperature characteristics.

Next, the lithium salt that is used in the electrolytic solution is not particularly limited, but among inorganic lithium salts, LiPF₆, LiBF₄, LiClO₄, LiI, LiCl, LiBr, or the like may be used, and among organic lithium salts, LiB [OCOCF₃] ₄, LiB [OCOCF₂CF₃]₄, LiPF₄ (CF₃)₂, LiN(SO₂CF₃)₂, LiN(SO₂CF₂CF₃)₂, or the like may be used. Particularly, LiPF₆, which is frequently used for consumer use batteries, is a material that is very suitable in stability of quality. In addition, LiB[OCOCF₃]₄ has preferable dissociation and solubility, and thereby exhibiting high conductivity with a low concentration. As a result, the LiB[OCOCF₃]₄ is an effective material.

As described above, according to an embodiment of the invention, it is possible to provide a lithium ion battery in which deterioration during storage at high temperatures of 50° C. or more is suppressed without deteriorating output characteristics at room temperature compared to a lithium ion battery in the related art, such that the lithium ion battery may be widely used as a power supply of a hybrid vehicle, and a power supply or a backup power supply of an electric control system of a vehicle, which may be exposed to high temperatures of 50° C. or more, and is also suitable for a power supply of industrial equipments such as electric power tools and fork lifts.

Hereinafter, specific examples of the preferred embodiment to execute the invention will be described.

### EXAMPLE 1

Manufacturing of Coated Negative-Electrode Active Material

As a negative-electrode active material, 10 weight parts of pseudo-anisotropic carbon, which is amorphous carbon, was dispersed in 90 weight parts of an acetonitrile solution in which the content rate of polyethylene carbonate (PEC) (a number-average molecular weight is 50,000) is 1 wt %. This dispersed solution that was obtained was left as is for six hours in an organic draft. Then, the negative-electrode active material precipitated in the dispersed solution, and 70 weight parts of supernatant liquid was removed. The remaining precipitate was dried in an atmosphere of 80° C. for 12 hours, and thereby a negative-electrode active material in which aggregation was substantially not present was obtained. Whether or not PEC that was coated on the negative-electrode active material is present was confirmed by measuring a diffuse reflection type infrared absorption spectrum and by observing characteristic stretching vibration of a functional group included in PEC. In this example, particularly, in regard to PEC, the stretching vibration of carbonyl was observed and thereby the presence of the polymer was confirmed.

Manufacturing of Wound-Type Battery

A wound-type battery of this example was manufactured by a method described below. The FIGURE shows a one-side cross-sectional view of a wound-type battery.

First, a positive-electrode material paste was prepared by using LiMn_{1/3}Ni_{1/3}Co_{1/3}O₂ as a positive-electrode active material, carbon black (CB1) and graphite (GF2) as an electronic conductive material, polyvinylidene fluoride (PVDF) as a binder, and NMP (N-methyl pyrrolidone) as a solvent in such a manner that the weight of solid content at the time of being dried became a ratio of LiMn_{1/3}Ni_{1/3}Co_{1/3}O₂:CB1:GF2:PVDF=86:9:2:3.

This positive-electrode material paste was applied onto aluminum foil that serves as a positive-electrode collector 1, was dried at 80° C., was pressed by a pressing roller, and was dried at 120° C. to form a positive-electrode mixture layer 2 on the positive-electrode collector 1.

Next, a negative-electrode material paste was prepared by using the coated negative-electrode active material, carbon black (CB2) as a conducting material, PVDF as a binder, and NMP as a solvent in such a manner that the weight of solid content at the time of being dried became a ratio of the coated negative-electrode active material:CB2:PVDF=88:5:7.

This negative-electrode material paste was applied onto copper foil that serves as a negative-electrode collector 3, was dried at 80° C., was pressed by a pressing roller, and was dried at 120° C. to form a negative-electrode mixture layer 4 on the negative-electrode collector 3.

A mixture obtained by mixing solvents with a volume composition ratio of EC:DMC:EMC=20:40:40 was used as an electrolytic solution, and then 1M of LiPF₆ as a lithium salt was dissolved, and thereby an electrolyte was prepared.

A separator 7 was interposed between the electrodes that were manufactured to form a group to be wound, and this group was inserted into a negative-electrode battery casing 13. Then, one end of a negative-electrode lead 9 made of nickel was welded to the negative-electrode collector 3 so as to take out collected electricity of the negative electrode and the other end was welded to the negative-electrode battery casing 13. In addition, one end of a positive-electrode lead 10 was welded to the positive-electrode collector 1 made of aluminum so as to take out collected electricity of the positive electrode and the other end was welded to a current interrupting valve 8 and is electrically connected to a positive-electrode battery cover 15 through this current interrupting valve 8. Furthermore, injection of the electrolytic solution and caulking were performed to manufacture the wound-type battery.

In addition, in the FIGURE, a positive-electrode insulator, a negative-electrode insulator, a gasket, and the positive-electrode battery cover are designated by reference numerals 11, 12, 14, and 15, respectively.

Evaluation of Battery

A capacity retention rate and direct-current resistance (DCR) of the wound-type battery shown in the FIGURE during storage at 70° C. were evaluated in the order described below. The capacity retention rate during storage at 70° C. shows film stability at high temperatures, and is mainly caused by the thickness of the film, a structure of molecules making up the film, and a component of the film. It can be said that as the capacity retention rate becomes high, the high-temperature storage characteristics are high. As the direct-current resistance (DCR), initial DCR and a DCR variation rate with respect to the initial DCR after storage were measured. The initial DCR represents a resistance value of the battery and is mainly caused by ion conductivity of the film. It can be said that as an initial DCR value becomes low, the ion conductivity of the film becomes high, the resistance of the film becomes low, and the output of the battery becomes high.

Method of Measuring Capacity Retention Rate

The battery was charged to 4.1 V with a constant current of 0.7 A and was charged with a constant voltage of 4.1 V until a current value becomes 20 mA. After operation stoppage for 30 minutes, the battery was discharged to 2.7 V with 0.7 A. This operation was repeated five times. A discharge capacity at the fifth operation was set to an initial capacity. Next, the battery after being stored at 70° C. was charged to 4.1 V with a constant current of 0.7 A and was charged with a constant voltage of 4.1 V until the current value becomes 20 mA. After operation stoppage for 30 minutes, the battery was discharged to 2.7 V with 0.7 A. This operation was repeated two times. The discharge capacity at the second operation was set to a capacity after storage. A storage date was set to 14 days and 30 days. The temperature at the time of measurement was 25° C. The capacity after storage with respect to the initial capacity was defined as the capacity retention rate and this result is shown in Table 1.

Method of Evaluating DCR

The battery was charged to 4.1 V with a constant current of 0.7 A and was charged with a constant voltage of 4.1 V until a current value becomes 20 mA. After operation stoppage for 30 minutes, the battery was discharged to 2.7 V with 0.7 A. This operation was repeated three times.

Next, the battery was charged to 3.8 V with a constant current of 0.7 A, was discharged with 10 A for 10 seconds, was again charged to 3.8 V with a constant current, was discharged with 20 A for 10 seconds, was again charged to 3.8 V, and was discharged with 30 A for 10 seconds. The DCR of the battery was evaluated from I-V characteristics at this time. The temperature at the time of measurement was 25° C. A rate of the DCR after storage with respect to the initial DCR was defined as the DCR variation rate and this result is shown in Table 1.

### EXAMPLE 2

Manufacturing of Coated Negative-electrode Active Material

As a negative-electrode active material, 10 weight parts of pseudo-anisotropic carbon, which is amorphous carbon, was dispersed in 90 weight parts of an acetonitrile solution in which the content rate of polyethylene carbonate (PEC) (a number-average molecular weight is 50,000) is 1 wt %. This dispersed solution that was obtained was left as is for six hours in an organic draft. Then, the negative-electrode active material precipitated in the dispersed solution, and 70 weight parts of supernatant liquid was removed. The remaining precipitate was dried in an atmosphere of 80° C. for 12 hours, and thereby a PEC-coated negative-electrode active material in which aggregation was substantially not present was obtained. Furthermore, the PEC-coated negative-electrode active material was dispersed in a dimethyl carbonate solution in which the content rate of vinylene carbonate (VC) is 5 wt % and which contains 0.1 wt % of 2,2′-azobisisobutyronitrile (AIBN) as a radical polymerization initiator. This dispersed solution that was obtained was left as is for six hours in an organic draft. Then, the negative-electrode active material precipitated in the dispersed solution, and 70 weight parts of supernatant liquid was removed. The remaining precipitate was dried in an atmosphere of 30° C. for 12 hours, and then was left as is in an atmosphere of 80° C. for 12 hours, and thereby a VC-cross-linked and PEC-coated negative-electrode active material in which aggregation was substantially not present was obtained. Hereinafter, the manufacturing and evaluation of the battery were performed with the same method as Example 1 except that the obtained negative-electrode active material was used. This result is shown in Table 1.

### EXAMPLE 3

Manufacturing of Coated Negative-Electrode Active Material

With respect to 100 weight parts of pseudo-anisotropic carbon that is amorphous carbon as the negative-electrode active material, a dispersed solution, which was obtained by dispersing vinyl triethoxysilane in pure water in advance in such a manner that concentration thereof becomes 10 weight %, was added in an amount corresponding to 1 weight part and was sufficiently mixed. Then, the resultant mixture was vacuum-dried at 150° C. for two hours, and thereby a silane-treated negative-electrode active material was obtained. Next, 10 weight parts of the silane-treated negative-electrode active material was dispersed in 90 weight parts of an acetonitrile solution in which the content rate of polyethylene carbonate (PEC) is 1 wt %. This dispersed solution that was obtained was left as is for six hours in an organic draft. Then, the negative-electrode active material precipitated in the dispersed solution, and 70 weight parts of supernatant liquid was removed. The remaining precipitate was dried in an atmosphere of 80° C. for 12 hours, and thereby a PEC-coated negative-electrode active material in which aggregation was substantially not present was obtained. Furthermore, the PEC-coated negative-electrode active material was dispersed in a dimethyl carbonate solution in which the content rate of vinylene carbonate (VC) is 5 wt % and which contains 0.1 wt % of 2,2′-azobisisobutyronitrile (AIBN) as a radical polymerization initiator. This dispersed solution that was obtained was left as is for six hours in an organic draft. Then, the negative-electrode active material precipitated in the dispersed solution, and 70 weight parts of supernatant liquid was removed. The remaining precipitate was dried in an atmosphere of 30° C. for 12 hours, and then was left as is in an atmosphere of 80° C. for 12 hours, and thereby a VC-cross-linked and PEC-coated negative-electrode active material in which aggregation was substantially not present was obtained. Hereinafter, the manufacturing and evaluation of the battery were performed with the same method as Example 1 except that the obtained negative-electrode active material was used. This result is shown in Table 1.

### EXAMPLE 4

The manufacturing and evaluation of the battery were performed with the same method as Example 2 except that dimethallyl carbonate (DMAC) was used in place of VC in Example 2. This result is shown in Table 1.

### EXAMPLE 5

The manufacturing and evaluation of the battery were performed with the same method as Example 3 except that dimethallyl carbonate (DMAC) was used in place of VC in Example 3. This result is shown in Table 1.

### EXAMPLE 6

The manufacturing and evaluation of the battery were performed with the same method as Example 5 except that polyethylene carbonate (PEC) (a number-average molecular weight is 10,000) was used in place of polyethylene carbonate (PEC) (a number-average molecular weight is 50, 000) in Example 1. This result is shown in Table 1.

### EXAMPLE 7

Manufacturing of Coated Negative-Electrode Active Material

20 weight parts of a boric acid esterified product of diethylene glycol monomethacrylate, and 108 weight parts of a boric acid esterified product of triethylene glycol monomethyl ether were mixed and dissolved, and then 0.19 weight parts of 2,2′-azobisisobutyronitrile as a polymerization initiator was mixed and dissolved to the resultant mixture, and thereby polyethylene glycol boric acid ester (PEGBE) was obtained. Next, as a negative-electrode active material, 90 weight parts of pseudo-anisotropic carbon that is amorphous carbon was mixed with 10 weight parts of PEGBE by a ball mill method for two hours, and thereby a PEGBE-coated negative-electrode active material was obtained. Whether or not PEGBE that was coated on the negative-electrode active material is present was confirmed by measuring a diffuse reflection type infrared absorption spectrum and by observing characteristic stretching vibration of a functional group included in PEGBE. In this example, particularly, in regard to PEGBE, stretching vibration of C—O was observed and thereby the presence of the polymer was confirmed. Hereinafter, the manufacturing and evaluation of the battery were performed with the same method as Example 1 except that the obtained negative-electrode active material was used. This result is shown in Table 1.

### EXAMPLE 8

Manufacturing of Coated Negative-Electrode Active Material

20 weight parts of a boric acid esterified product of diethylene glycol monomethacrylate, and 108 weight parts of a boric acid esterified product of triethylene glycol monomethyl ether were mixed and dissolved, and then 0.19 weight parts of 2,2′-azobisisobutyronitrile as a polymerization initiator was mixed and dissolved to the resultant mixture, and thereby polyethylene glycol boric acid ester (PEGBE) was obtained. Next, as a negative-electrode active material, 90 weight parts of pseudo-anisotropic carbon that is amorphous carbon was mixed with 10 weight parts of PEGBE by a ball mill method for two hours, and thereby a PEGBE-coated negative-electrode active material was obtained. The PEGBE-coated negative-electrode active material was dispersed in a dimethyl carbonate solution in which the content rate of vinylene carbonate (VC) is 5 wt % and which contains 0.1 wt % of 2,2′-azobisisobutyronitrile (AIBN) as a radical polymerization initiator. This dispersed solution that was obtained was left as is for six hours in an organic draft. Then, the negative-electrode active material precipitated in the dispersed solution, and 70 weight parts of supernatant liquid was removed. The remaining precipitate was dried in an atmosphere of 30° C. for 12 hours, and then was left as is in an atmosphere of 80° C. for 12 hours, and thereby a VC-cross-linked and PEGBE-coated negative-electrode active material in which aggregation was substantially not present was obtained. Hereinafter, the manufacturing and evaluation of the battery were performed with the same method as Example 1 except that the obtained negative-electrode active material was used. This result is shown in Table 1.

### EXAMPLE 9

Manufacturing of Coated Negative-Electrode Active Material

20 weight parts of a boric acid esterified product of diethylene glycol monomethacrylate, and 108 weight parts of a boric acid esterified product of triethylene glycol monomethyl ether were mixed and dissolved, and then 0.19 weight parts of 2,2′-azobisisobutyronitrile as a polymerization initiator was mixed and dissolved to the resultant mixture, and thereby polyethylene glycol boric acid ester (PEGBE) was obtained. Next, with respect to 100 weight parts of pseudo-anisotropic carbon that is amorphous carbon as the negative-electrode active material, a dispersed solution, which was obtained by dispersing vinyl triethoxysilane in pure water in advance in such a manner that concentration thereof becomes 10 weight %, was added in an amount corresponding to 1 weight part and was sufficiently mixed. Then, the resultant mixture was vacuum-dried at 150° C. for two hours, and thereby a silane-treated negative-electrode active material was obtained. 90 weight parts of the silane-treated negative-electrode active material was mixed with 10 weight parts of PEGBE by a ball mill method for two hours, and thereby a PEGBE-coated negative-electrode active material was obtained. Furthermore, the PEGBE-coated negative-electrode active material was dispersed in a dimethyl carbonate solution in which the content rate of vinylene carbonate (VC) is 5 wt % and which contains 0.1 wt % of 2,2′-azobisisobutyronitrile (AIBN) as a radical polymerization initiator. This dispersed solution that was obtained was left as is for six hours in an organic draft. Then, the negative-electrode active material precipitated in the dispersed solution, and 70 weight parts of supernatant liquid was removed. The remaining precipitate was dried in an atmosphere of 30° C. for 12 hours, and then was left as is in an atmosphere of 80° C. for 12 hours, and thereby a VC-cross-linked and PEGBE-coated negative-electrode active material in which aggregation was substantially not present was obtained. Hereinafter, the manufacturing and evaluation of the battery were performed with the same method as Example 1 except that the obtained negative-electrode active material was used. This result is shown in Table 1.

### EXAMPLE 10

The manufacturing and evaluation of the battery were performed with the same method as Example 7 except that dimethallyl carbonate (DMAC) was used in place of VC in Example 7. This result is shown in Table 1.

### EXAMPLE 11

The manufacturing and evaluation of the battery were performed with the same method as Example 8 except that dimethallyl carbonate (DMAC) was used in place of VC in Example 8. This result is shown in Table 1.

### COMPARATIVE EXAMPLE 1

The manufacturing and evaluation of the battery were performed with the same method as Example 1 except that a coating-untreated negative-electrode active material was used in place of the PEC-coated negative-electrode active material in Example 1. This result is shown in Table 1.

### COMPARATIVE EXAMPLE 2

The manufacturing and evaluation of the battery were performed with the same method as Example 1 except that polyethylene oxide (PEO) was used in place of PEC in Example 1. This result is shown in Table 1.

TABLE 1

| | | | | Capacity | Capacity | | DCR | DCR |
|---|---|---|---|---|---|---|---|---|
| | | | | retention | retention | Initial | variation | variation |
| | | Cross- | | rate | rate | DCR | rate | rate |
| | Kind of | linking | Surface | @after 14 | @after 30 | @25° C. | @after 14 | @after 30 |
| | coating | agent | treatment | days (%) | days (%) | (mΩ) | days (%) | days (%) |
| Example 1 | PEC | — | — | 84.5 | 82.1 | 62.1 | 107.1 | 110.5 |
| Example 2 | PEC | VC | — | 84.7 | 82.6 | 62.4 | 106.7 | 110.2 |
| Example 3 | PEC | VC | Silane | 86.5 | 82.9 | 62.5 | 105.7 | 109.7 |
| Example 4 | PEC | DMAC | — | 87.8 | 86.2 | 62.4 | 105.1 | 109.4 |
| Example 5 | PEC | DMAC | Silane | 88 | 87.1 | 62.7 | 105.1 | 109.1 |
| Example 6 | PEC | — | — | 83.2 | 80.1 | 62.5 | 107.5 | 110.8 |
| Example 7 | PEGBE | — | — | 84.8 | 82.3 | 63.1 | 107.3 | 111.3 |
| Example 8 | PEGBE | VC | — | 85.2 | 82.9 | 63.4 | 107.1 | 111.1 |
| Example 9 | PEGBE | VC | Silane | 86.1 | 83.8 | 63.5 | 107.1 | 110.8 |
| Example 10 | PEGBE | DMAC | — | 87.5 | 85.6 | 63.8 | 106.8 | 110.4 |
| Example 11 | PEGBE | DMAC | Silane | 88.1 | 86.5 | 64.2 | 106.4 | 110.1 |
| Comparative | — | — | — | 81.4 | 74.8 | 65 | 109.3 | 112.6 |
| Example 1 | | | | | | | | |
| Comparative | PEO | — | — | 82.1 | 75.6 | 82 | 108.2 | 111.4 |
| Example 2 | | | | | | | | |

In the batteries of Examples 1 to 6 in which the negative-electrode active material is coated with PEC, and the batteries of Examples 7 to 11 in which the negative-electrode active material is coated with PEGBE, the capacity retention rate during high-temperature storage is higher, the initial DCR is lower, and the DCR variation rate is suppressed to be smaller compared to the battery of Comparative Example 1 in which the negative-electrode is not coated. In addition, in the batteries of Examples, it was confirmed that performance in regard to the capacity retention rate during high-temperature storage, the initial DCR, and the DCR variation rate was improved compared to the battery of Comparative Example 2 in which the coating is performed with PEO.

According to the invention, it is possible to provide a lithium ion battery in which the capacity retention rate for 30 days of a storage date is higher than 75.6%, and the initial DCR is lower than 65 mΩ.

Comparative Example 1 shows a result when a coating-untreated negative-electrode active material is used. Since the negative-electrode active material is not coated, when the battery operates, a component in the electrolytic solution is reductively decomposed and thereby a film is generated on a surface of the negative-electrode active material. Since this film has high electronic conductivity, decomposition and precipitation of the electrolytic solution component occur on the film and therefore the film grows continuously. As a result, in Comparative Example 1, the capacity retention rate is lower and the DCR variation rate is higher compared to Comparative Example 2 and Examples 1 to 11 in which the coating treatment is performed.

Comparative Example 2 shows a result when PEO is coated on the negative-electrode active material. Since the coated film using PEO is formed, the capacity retention rate is higher, and the DCR variation rate is suppressed to be lower compared to Comparative Example 1.

In Examples 1 to 11, since the compounds, which are expressed by Formula 1 and Formula 2 and which have ion conductivity higher than that of PEO, are used as a coating film, the initial DCR value is suppressed to be lower compared to Comparative Example 2. In addition, in Examples 1 to 11, the capacity retention rate is higher and the DCR variation rate is suppressed to be lower compared to Comparative Example 2. Since a charge may smoothly flow in a polymer having high ion conductivity, leakage of the charge into the electrolytic solution component less occurs. As a result, precipitation of the electrolytic solution component is suppressed and therefore an increase in the resistance of the battery may be suppressed.

The initial DCR of the batteries of Examples 1 to 6 in which the negative-electrode active material is coated with PEC is lower than the initial DCR of the batteries of Examples 7 to 11 in which the negative-electrode active material is coated with PEGBE. This is considered to be because the ion conductivity of PEC is higher than that of PEGBE.

In Examples 2 to 5 and Examples 8 to 11 in which VC and DMAC are used as the cross-linking agents, the capacity retention rate is higher and the DCR variation rate is lower compared to Examples 1 and 7 in which the cross-linking agent is not used. This is considered to be because stability of the film is increased by the cross-linking agent. In addition, in Examples 4, 5, 10, and 11 in which DMAC is used as the cross-linking agent, the capacity retention rate is higher and the DCR variation rate is lower compared to Examples 2, 3, 8 and 9 in which VC is used as the cross-linking agent. This is considered to be because the cross-linking structure of VC has a linear chain shape, and in contrast, the cross-linking structure of DMAC has a diverged shape and thereby the cross-linking structure thereof is stronger than that of VC.

In addition, in Examples 3, 5, 9, and 11 in which the surface treatment is performed, the capacity retention rate is higher and the DCR variation rate is lower compared to Examples 2, 4, 8, and 10 in which the surface treatment is not performed. The mechanism by which an excellent effect maybe obtained by the silane treatment is not clear, but this is considered to be because surface adsorbed water or a surface functional group, which is considered to chemically react with lithium and does not contribute to the charging and discharging reaction of the battery, decreases due to improvement of a water resisting property and a lipophillic property.

As described above, according to the invention, a secondary battery, in which deterioration during storage at high temperatures of 50° C. or more is suppressed while the DCR at 25° C. is improved, may be provided.

1. A lithium ion battery, comprising:
a positive electrode that is capable of occluding and emitting lithium ions;
a negative electrode that is capable of occluding and emitting lithium ions;
a separator that is disposed between the positive electrode and the negative electrode; and
an electrolytic solution,
wherein the negative electrode includes a negative-electrode active material and a polymer,
a surface of the negative-electrode active material is entirely or partially coated with the polymer, and
the polymer includes polyethylene glycol boric acid ester that can be obtained by polymerizing an aliphatic polycarbonate expressed by Formula 1 or a polymerizable boron compound expressed by Formula 2 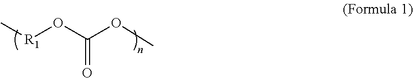
wherein, R₁ represents a hydrocarbon group having a carbon number of 2 to 7, and
n is larger than 10 and less than 10,000 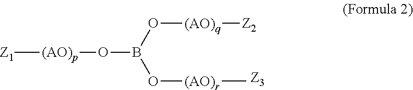
wherein, Z₁, Z₂, and Z₃ represent organic groups having an acryloyl group or a methacryloyl group, or hydrocarbon groups having a carbon number of 1 to 10, in which one, two, or three of Z₁, Z₂, and Z₃ are the organic groups having the acryloyl group or methacryloyl group,
AO represents an oxyalkylene group having a carbon number of 1 to 6, and is composed of one kind or two or more kinds thereof, and
p, q, and r represent the an average addition number of moles of the oxyalkylene group, and are larger than 0 and less than 4, in which p+q+r is 3 or more.

2. The lithium ion battery according to claim 1,
wherein R₁ represents a hydrocarbon group having a carbon number of 2 to 3, and
n is larger than 100 and is less than 1,000.

3. The lithium ion battery according to claim 1,
wherein the polymer is cross-linked by a cross-linking agent.

4. The lithium ion battery according to claim 3,
wherein the cross-linking agent includes a circular carbonate expressed by Formula 3 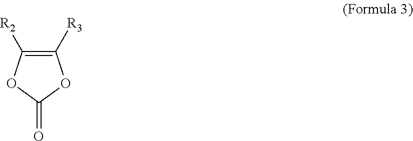
wherein, R₂ and R₃ represent any one of hydrogen, fluorine, chlorine, an alkyl group having a carbon number of 1 to 3, and a fluorinated alkyl group.

5. The lithium ion battery according to claim 3,
wherein the cross-linking agent includes a chain-shaped carbonate expressed by Formula 4 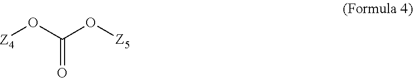
wherein, Z₄ and Z₅ represent a polymerizable functional group including at least one kind of an allyl group, a methallyl group, a vinyl group, an acryl group, and a methacryl group.

6. The lithium ion battery according to claim 1,
wherein the negative-electrode active material is subjected to a silane treatment, an aluminum treatment, or a titanium treatment.

7. The lithium ion battery according to claim 1,
wherein a capacity retention rate of the lithium ion battery for 30 days of a storage date is higher than 75.6%.

8. The lithium ion battery according to claim 1,
wherein an initial DCR of the lithium ion battery is lower than 65 mΩ.

9. The lithium ion battery according to claim 1,
wherein the positive electrode includes a positive-electrode active material, and
the positive-electrode active material includes lithium composite oxides that are expressed by a compositional formula of Li_{α}MnₓM1_{y}M2_{z}O₂ wherein, M1 represents at least one kind selected from Co and Ni, M2 represents at least one kind selected from Co, Ni, Al, B, Fe, Mg, and Cr, x+y+z=1, 0<α<1.2, 0.2≦x≦0.6, 0.2≦y≦0.4, and 0.05≦z≦0.4.

10. The lithium ion battery according to claim 9,
wherein the negative-electrode active material includes at least one kind of a carbonaceous material, an oxide including a group IV element, and a nitride including a group IV element.
